(19) United States
(12) Patent Application Publication
(10) Pub. No.: US 2024/0089724 A1
(43) Pub. Date: Mar. 14, 2024

(54) MULTIPLEXING AT A FORWARDING NODE

(71) Applicant: QUALCOMM Incorporated, San Diego, CA (US)

(72) Inventors: Yehonatan DALLAL, Kfar Saba (IL); Amit BAR-OR TILLINGER, Tel-Aviv (IL); Idan Michael HORN, Hod Hasharon (IL); Shay LANDIS, Hod Hasharon (IL)

(21) Appl. No.: 17/931,875

(22) Filed: Sep. 13, 2022

(51) Int. Cl. H04W 8/22; H04W 28/02; H04W 48/16; H04W 72/04

(52) U.S. Cl. CPC H04W 8/22; H04W 28/0215; H04W 48/16; H04W 72/0453; H04W 72/048

(57) ABSTRACT

Various aspects of the present disclosure generally relate to wireless communication. In some aspects, a network node may transmit, to a parent network node, information associated with a multiplexing compatibility of the network node for communications with a first mobile station and a second mobile station, the first mobile station and the second mobile station connected to the parent network node via the network node. The network node may receive, from the parent network node, a first communication for the first mobile station and a second communication for the second mobile station, the first communication and the second communication multiplexed based at least in part on the information associated with the multiplexing compatibility of the network node for communications with the first mobile station and the second mobile station. Numerous other aspects are described.

### FIELD OF THE DISCLOSURE

Aspects of the present disclosure generally relate to wireless communication and to techniques and apparatuses for multiplexing at a forwarding node.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a network node. The method may include transmitting, to a parent network node, information associated with a multiplexing compatibility of the network node for communications with a first mobile station and a second mobile station, the first mobile station and the second mobile station connected to the parent network node via the network node. The method may include receiving, from the parent network node, a first communication for the first mobile station and a second communication for the second mobile station, the first communication and the second communication multiplexed based at least in part on the information associated with the multiplexing compatibility of the network node for communications with the first mobile station and the second mobile station.

Some aspects described herein relate to a method of wireless communication performed by a parent network node. The method may include receiving, from a network node, information associated with a multiplexing compatibility of the network node for communications with a first mobile station and a second mobile station, the first mobile station and the second mobile station connected to the parent network node via the network node. The method may include transmitting, to the network node, a first communication for the first mobile station and a second communication for the second mobile station, the first communication and the second communication multiplexed based at least in part on the information associated with the multiplexing compatibility of the network node for communications with the first mobile station and the second mobile station.

Some aspects described herein relate to a network node for wireless communication. The network node may include a memory and one or more processors coupled to the memory. The one or more processors may be configured to transmit, to a parent network node, information associated with a multiplexing compatibility of the network node for communications with a first mobile station and a second mobile station, the first mobile station and the second mobile station connected to the parent network node via the network node. The one or more processors may be configured to receive, from the parent network node, a first communication for the first mobile station and a second communication for the second mobile station, the first communication and the second communication multiplexed based at least in part on the information associated with the multiplexing compatibility of the network node for communications with the first mobile station and the second mobile station.

Some aspects described herein relate to a parent network node for wireless communication. The parent network node may include a memory and one or more processors coupled to the memory. The one or more processors may be configured to receive, from a network node, information associated with a multiplexing compatibility of the network node for communications with a first mobile station and a second mobile station, the first mobile station and the second mobile station connected to the parent network node via the network node. The one or more processors may be configured to transmit, to the network node, a first communication for the first mobile station and a second communication for the second mobile station, the first communication and the second communication multiplexed based at least in part on the information associated with the multiplexing compatibility of the network node for communications with the first mobile station and the second mobile station.

Some aspects described herein relate to a non-transitory computer-readable medium that stores a set of instructions for wireless communication by a network node. The set of instructions, when executed by one or more processors of the network node, may cause the network node to transmit, to a parent network node, information associated with a multiplexing compatibility of the network node for communications with a first mobile station and a second mobile station, the first mobile station and the second mobile station connected to the parent network node via the network node. The set of instructions, when executed by one or more processors of the network node, may cause the network node to receive, from the parent network node, a first communication for the first mobile station and a second communication for the second mobile station, the first communication and the second communication multiplexed based at least in part on the information associated with the multiplexing compatibility of the network node for communications with the first mobile station and the second mobile station.

Some aspects described herein relate to a non-transitory computer-readable medium that stores a set of instructions for wireless communication by a parent network node. The set of instructions, when executed by one or more processors of the parent network node, may cause the parent network node to receive, from a network node, information associated with a multiplexing compatibility of the network node for communications with a first mobile station and a second mobile station, the first mobile station and the second mobile station connected to the parent network node via the network node. The set of instructions, when executed by one or more processors of the parent network node, may cause the parent network node to transmit, to the network node, a first communication for the first mobile station and a second communication for the second mobile station, the first communication and the second communication multiplexed based at least in part on the information associated with the multiplexing compatibility of the network node for communications with the first mobile station and the second mobile station.

Some aspects described herein relate to an apparatus for wireless communication. The apparatus may include means for transmitting, to a parent network node, information associated with a multiplexing compatibility of the network node for communications with a first mobile station and a second mobile station, the first mobile station and the second mobile station connected to the parent network node via the apparatus. The apparatus may include means for receiving, from the parent network node, a first communication for the first mobile station and a second communication for the second mobile station, the first communication and the second communication multiplexed based at least in part on the information associated with the multiplexing compatibility of the network node for communications with the first mobile station and the second mobile station.

Some aspects described herein relate to an apparatus for wireless communication. The apparatus may include means for receiving, from a network node, information associated with a multiplexing compatibility of the network node for communications with a first mobile station and a second mobile station, the first mobile station and the second mobile station connected to the apparatus via the network node. The apparatus may include means for transmitting, to the network node, a first communication for the first mobile station and a second communication for the second mobile station, the first communication and the second communication multiplexed based at least in part on the information associated with the multiplexing compatibility of the network node for communications with the first mobile station and the second mobile station.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of multiplexing communications for different mobile stations on a beam of a network node, in accordance with the present disclosure.

FIG. 5 is a diagram illustrating an example of multiplexing communications for different mobile stations on a beam of a network node, in accordance with the present disclosure.

FIG. 6 is a diagram of an example associated with multiplexing at a forwarding node, in accordance with the present disclosure.

FIG. 7 is a diagram of an example associated with multiplexing at a forwarding node, in accordance with the present disclosure.

FIG. 8 is a diagram illustrating examples of beam management procedures, in accordance with the present disclosure.

FIG. 9 is a diagram illustrating an example process performed, for example, by a network node, in accordance with the present disclosure.

FIG. 10 is a diagram illustrating an example process performed, for example, by a parent network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

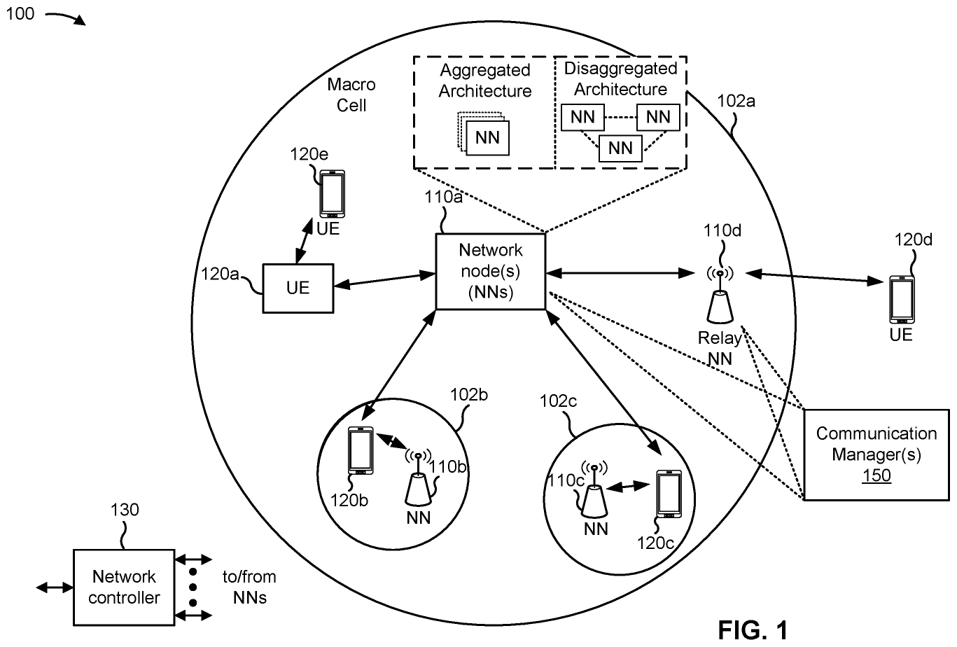

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the network node 110 may include a communication manager 150. As described in more detail elsewhere herein, the communication manager 150 may transmit, to a parent network node, information associated with a multiplexing compatibility of the network node for communications with a first mobile station and a second mobile station, the first mobile station and the second mobile station connected to the parent network node via the network node; and receive, from the parent network node, a first communication for the first mobile station and a second communication for the second mobile station, the first communication and the second communication multiplexed based at least in part on the information associated with the multiplexing compatibility of the network node for communications with the first mobile station and the second mobile station. Additionally, or alternatively, the communication manager 150 may perform one or more other operations described herein.

In some aspects, the parent network node 110 may include a communication manager 150. As described in more detail elsewhere herein, the communication manager 150 may receive, from a network node, information associated with a multiplexing compatibility of the network node for communications with a first mobile station and a second mobile station, the first mobile station and the second mobile station connected to the parent network node via the network node; and transmit, to the network node, a first communication for the first mobile station and a second communication for the second mobile station, the first communication and the second communication multiplexed based at least in part on the information associated with the multiplexing compatibility of the network node for communications with the first mobile station and the second mobile station.

As indicated above, FIG. 1 is provided as an example. Other examples may differ from what is described with regard to FIG. 1.

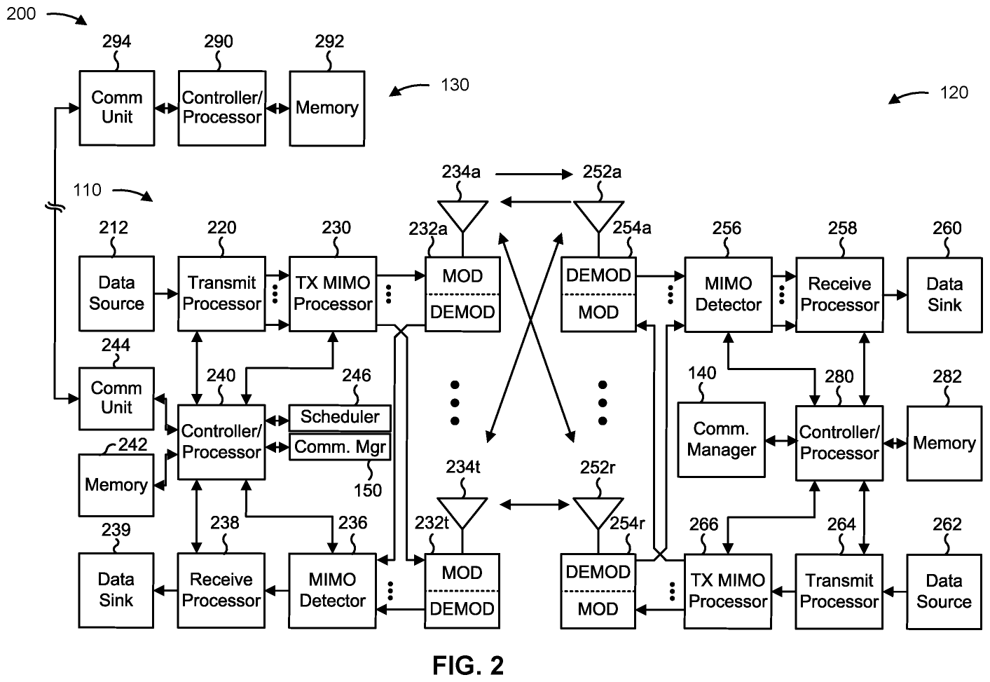

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MC S(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

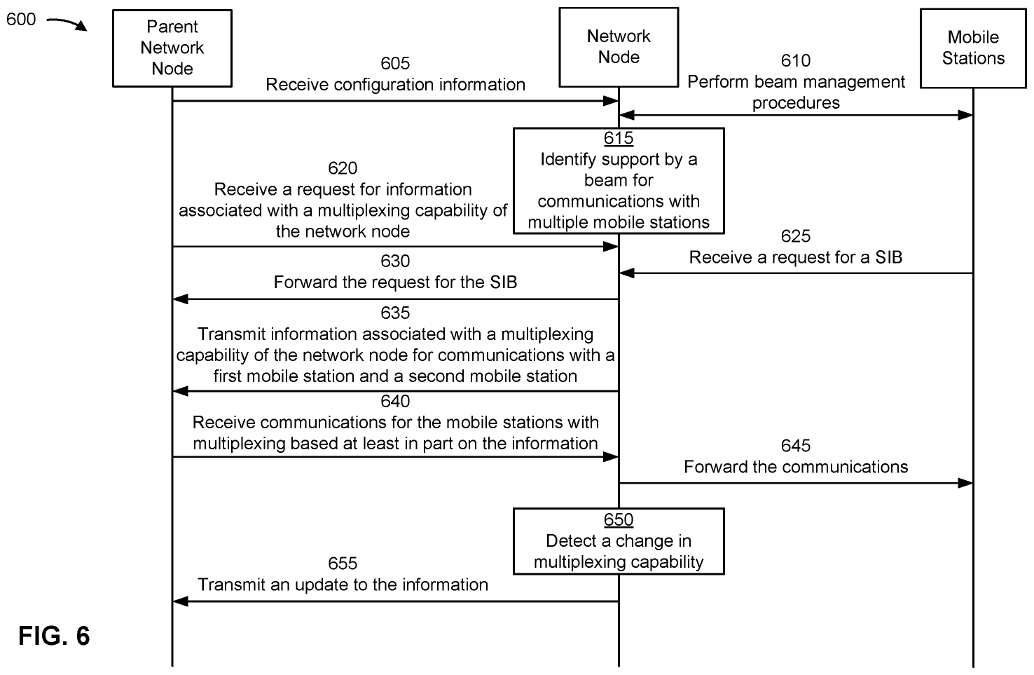

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-12).

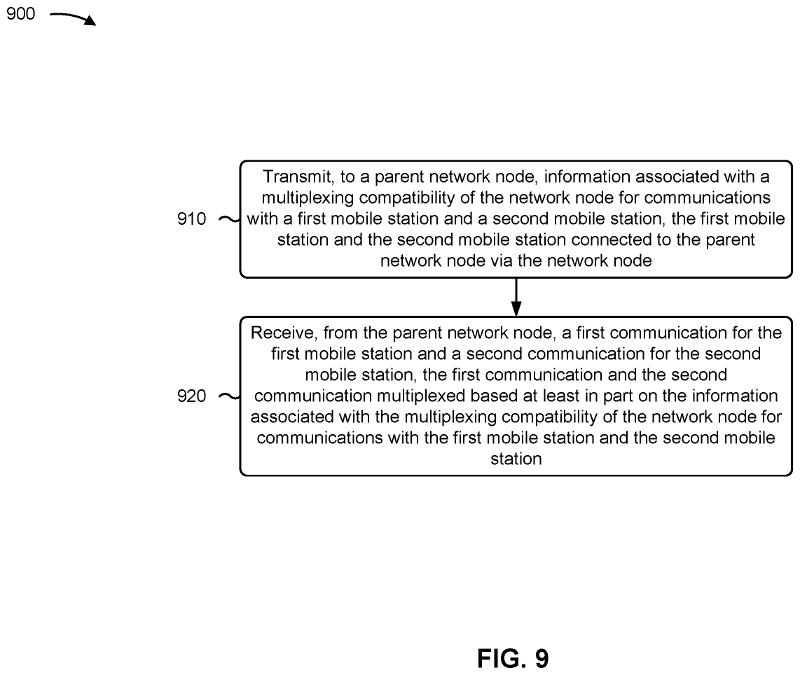

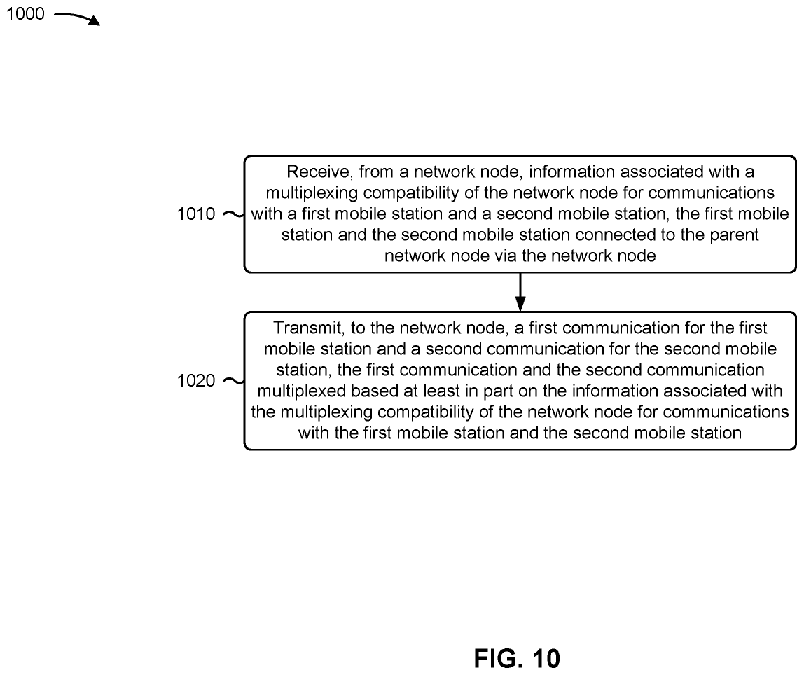

The controller/processor 240 of the network node 110, the controller/processor 280 of the UE 120, and/or any other component(s) of FIG. 2 may perform one or more techniques associated with multiplexing at a forwarding node (e.g., the network node 110), as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a network node 110 may include means for transmitting, to a parent network node, information associated with a multiplexing compatibility of the network node for communications with a first mobile station and a second mobile station, the first mobile station and the second mobile station connected to the parent network node via the network node; and means for receiving, from the parent network node, a first communication for the first mobile station and a second communication for the second mobile station, the first communication and the second communication multiplexed based at least in part on the information associated with the multiplexing compatibility of the network node for communications with the first mobile station and the second mobile station, among other examples. In some aspects, such means may include one or more components of network node 110 described in connection with FIG. 2, such as antenna 234, MIMO detector 236, receive processor 238, controller/processor 240, transmit processor 220, TX MIMO processor 230, modem 232, antenna 234, or the like.

In some aspects, a parent network node 110 may include means for receiving, from a network node, information associated with a multiplexing compatibility of the network node for communications with a first mobile station and a second mobile station, the first mobile station and the second mobile station connected to the parent network node via the network node; and means for transmitting, to the network node, a first communication for the first mobile station and a second communication for the second mobile station, the first communication and the second communication multiplexed based at least in part on the information associated with the multiplexing compatibility of the network node for communications with the first mobile station and the second mobile station, among other examples. In some aspects, such means may include one or more components of network node 110 described in connection with FIG. 2, such as antenna 234, MIMO detector 236, receive processor 238, controller/processor 240, transmit processor 220, TX MIMO processor 230, modem 232, antenna 234, or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

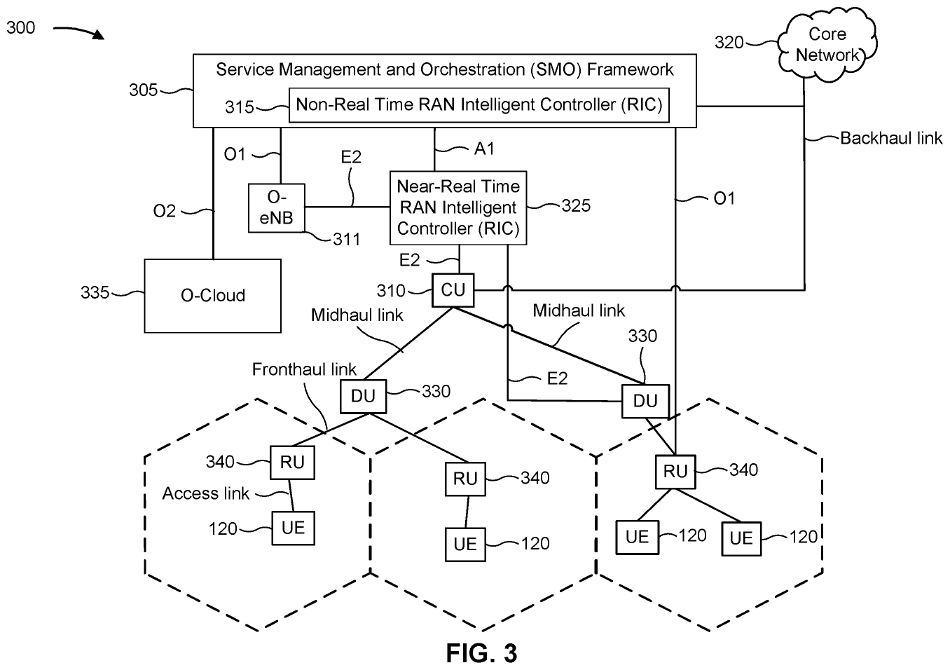

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 335) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as AI interface policies).

As indicated above, FIG. 3 is provided as an example. Other examples may differ from what is described with regard to FIG. 3.

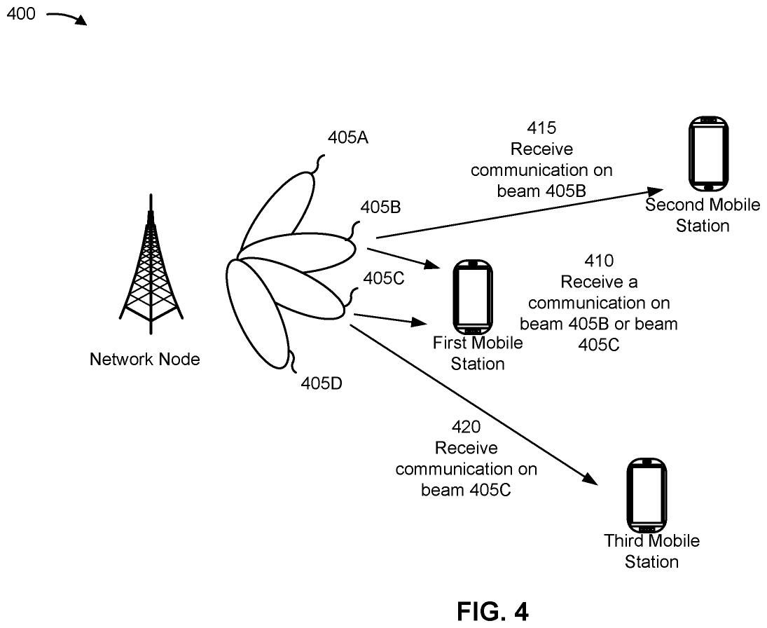

FIG. 4 is a diagram illustrating an example 400 of multiplexing communications for different mobile stations on a beam of a network node, in accordance with the present disclosure. As shown in FIG. 4, a network node may communicate with one or more a mobile stations (e.g., UE 120). The network node may communicate with a first mobile station, a second mobile station, and a third mobile station. The network node may be able to communicate with multiple mobile stations on a same beam, which may enable the network node to multiplex communications for the multiple mobile stations using frequency division multiplexing (FDM) (e.g., with simultaneous or overlapping time resources). For example, the network node may only be able to multiplex using FDM based at least in part on multiplexed communications being on a same beam.

The network node may operate a number of beams on which the network node communicates with the multiple mobile stations. For example, the network node may transmit communications to mobile stations on a set of beams 405A, 405B, 405C, and 405D.

As shown by reference number 410, the first mobile station may receive, and the network node may transmit, a communication via the beam 405B or via the beam 405C. As shown by reference number 415, the second mobile station may receive, and the network node may transmit, a communication via the beam 405B. As shown by reference number 420, the third mobile station may receive, and the network node may transmit, a communication via the beam 405C.

In example 400, the network node may multiplex communications using FDM to the first mobile station with communications to the second mobile station or with communications to the third mobile station. However, the network node may not multiplex communications using FDM to the second mobile station with communications to the third mobile station because the second mobile station and the third mobile station are not served and/or reachable via a same beam.

As indicated above, FIG. 4 is provided as an example. Other examples may differ from what is described with regard to FIG. 4.

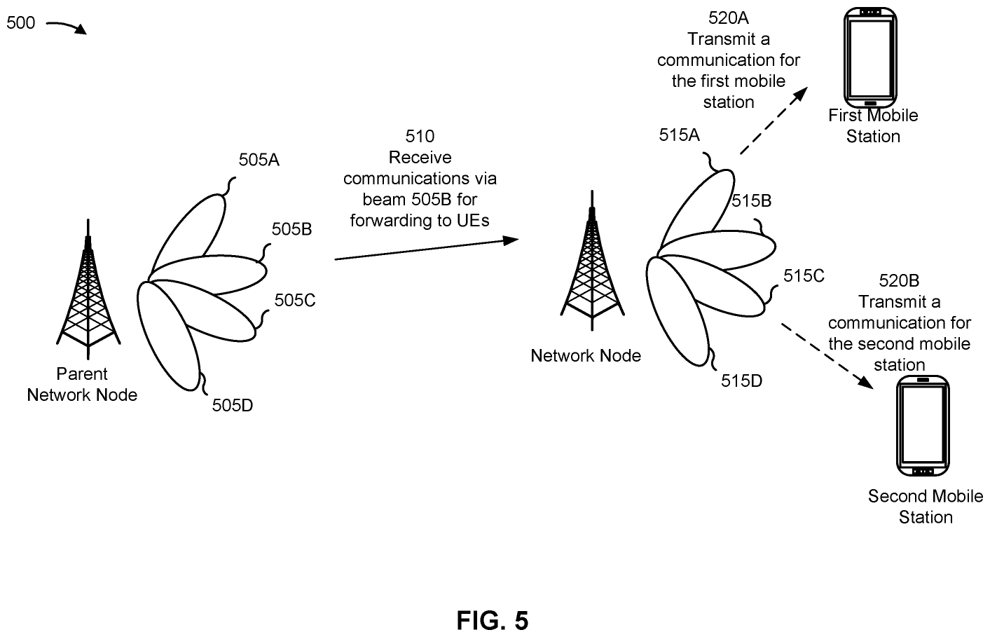

FIG. 5 is a diagram illustrating an example 500 of multiplexing communications for different mobile stations on a beam of a network node, in accordance with the present disclosure. As shown in FIG. 5, a parent network node may attempt to transmit communications, using FDM multiplexing, to a first mobile station (e.g., UE 120) and a second mobile station via a network node (e.g., a relay, a repeater, and/or a forwarding node, among other examples).

The parent network node may operate a number of beams on which the parent network node transmits communications to multiple mobile stations. For example, the network node may transmit communications to mobile stations on a set of beams 505A, 505B, 505C, and 505D.

As shown by reference number 510, the network node may receive the communications from the parent network node. The network node may determine that the communications that are multiplexed using FDM are for mobile stations that are not served by a same beam (e.g., a downlink transmission beam of the network node).

The network node may operate a number of beams on which the network node communicates with connected mobile stations. For example, the network node may support, operate, and/or communicate with mobile stations via a set of beams 515A, 515B, 515C, and 515D. However, the network node may not support FDM-based multiplexing (e.g., using simultaneous and/or overlapping communications) of communications on different beams.

Based at least in part on not supporting FDM of communications on different beams, the network node may transmit only one of the communications to only one of the mobile stations. For example, as shown by reference number 520A, the network node may transmit a communication for the first mobile station via the beam 515A. Alternatively, as shown by reference number 520B, the network node may transmit a communication for the second mobile station via the beam 515C.

Based at least in part on the network node not supporting FDM-based multiplexing of communications on different beams, one of the communications shown in example 500 will not be forwarded by the network node. Based at least in part on not forwarding one of the communications, a mobile station associated with the one communication may transmit an indication of a failure to receive the communication, which may trigger a retransmission of the communication. In this way, the network node may consume power, computing, network, and/or communication resources to detect and/or correct an error caused by failing to forward one of the communications.

As indicated above, FIG. 5 is provided as an example. Other examples may differ from what is described with regard to FIG. 5.

In some aspects described herein, a network node may transmit, to a parent network node, information associated with a multiplexing compatibility of the network node for communications with a first mobile station and a second mobile station. The first mobile station and the second mobile station may be connected to the parent network node via the network node. For example, the network node may indicate whether the network node supports FDM-based multiplexing of communications to the first mobile station and the second mobile station (e.g., based at least in part on the first mobile station and the second mobile station being reachable via a same beam of the network node).

The parent network node may transmit a first communication for the first mobile station and a second communication for the second mobile station, with the first communication and the second communication multiplexed based at least in part on the information associated with the multiplexing compatibility of the network node for communications with the first mobile station and the second mobile station. For example, the parent network node may transmit the first communication and the second communication with FDM-based multiplexing (e.g., using simultaneous transmission and/or overlapping time resources) based at least in part on the information indicating that the network node supports multiplexing communications for the first mobile station and the second mobile station using FDM-based multiplexing.

In some aspects, the network node may allocate connected mobile stations to different beams of the network node. For example, the network node may allocate the mobile stations to beams during initial acquisition of the mobile stations and/or during a beam management process. In some aspects, the network node (e.g., a repeater and/or forwarding node) may continuously track beams allocated to connected mobile stations (e.g., to maintain communication links with the mobile stations).

The parent network node may be aware that the parent network node may reach the connected mobile stations using a beam that points toward the network node. In this way, all network node served mobile stations appear to the parent network node as being served by a same beam of the parent network node.

The network node may provide the parent network node with information associated with multiplexing capabilities of the network node associated with forwarding communications to mobile stations served by the network node (e.g., in communication with the parent network node via the network node). For example, the network node may indicate multiple mobile stations that are served by a same beam of the network node (e.g., a list of UEs that can be multiplexed with allocations in a same slot).

In some aspects, the network node may initiate transmission of a report to the parent network node when multiple mobile stations are identified as sharing a same beam of the network node (e.g., a downlink transmission beam of the network node). This may happen when beams and/or beam assignments are changed due to mobile station motion and/or a changed configuration of the network node. In some aspects, the network node may initiate a periodic report with all mobile station groupings, even when there is no change in beams and/or beam assignments.

In some aspects, the parent network node may query the network node about pairs or groups of mobile stations that the parent network node would like to multiplex in subsequent allocations. The parent network node may query the network node periodically or semi-periodically and/or may indicate that the network node is to provide the information periodically or semi-periodically.

In some aspects, the information may include beam associations, such as a list of mobile stations (e.g., using mobile station identifiers) that can be multiplexed using FDM (e.g., using simultaneous transmission and/or overlapping time resources). For example, the information may indicate {{UE1,UE3}, {UE2,UE4}, {UE5}}.

In some aspects, the information may include a joint signal strength report. For example, the information may indicate RSRPs from all connected mobile stations for one or more beams of the network node. For example, two mobile stations may be allocated different beams but may support operation on a shared beam with reduced performance. In some aspects, the parent network node may use the information to, for example, transmit downlink control information (DCI) (with a small payload for the mobile station with a lower signal strength for the shared beam) with a future allocation to one of the mobile stations while transmitting data for the other (e.g., the mobile station with a higher signal strength for the shared beam), or similarly in uplink.

In some aspects, the network node may receive a mobile station request for a system information block (SIB) and may forward the mobile station request for the SIB (e.g., an extended SIB) to the parent network node. The network node may provide the information to the parent network node based at least in part on forwarding the mobile station request for the SIB to the parent network node. The information may include, for example, an indication of one or more additional mobile stations (e.g., in addition to the mobile station that transmitted the mobile station request) that may receive a downlink communication (e.g., downlink data and/or downlink control information) using FDM-based multiplexing (also referred to herein as FDM multiplexing) such that the downlink communication is FDM multiplexed with the SIB. For example, the one or more additional mobile stations may receive the downlink communication that is FDM-based multiplexed with the SIB based at least in part on the mobile station and the one or more additional mobile stations being reachable by a single beam (e.g., having a same downlink spatial filter applied by the network node).

Based at least in part on the network node providing the information associated with a multiplexing compatibility of the network node for communications with mobile stations connected to the parent network node via the network node, the parent network node may avoid multiplexing communications for incompatible mobile stations and/or conserve power, computing, network, and/or communication resources that may have otherwise been used to detect a failure of a communication that was not forwarded and/or to retransmit the communication.

FIG. 6 is a diagram of an example 600 associated with multiplexing at a forwarding node, in accordance with the present disclosure. As shown in FIG. 6, a network node (e.g., network node 110, an IAB node, a repeater, a forwarding node, a relay, a DU, and/or an RU) may communicate with a parent network node (e.g., network node 110, an IAB node, a repeater, a forwarding node, a relay, a CU, a DU, and/or an RU) and mobile stations (e.g., UEs 120). In some aspects, the network node, the parent network node, and/or the mobile stations may be part of a wireless network (e.g., wireless network 100). The network node, the parent network node, and/or the mobile stations may have established a wireless connection prior to operations shown in FIG. 6.

As shown by reference number 605, the parent network node may transmit, and the network node may receive, configuration information. In some aspects, the network node may receive the configuration information via one or more of RRC signaling, one or more MAC CEs, and/or downlink control information (DCI), among other examples. In some aspects, the configuration information may include an indication of one or more configuration parameters (e.g., already known to the network node and/or previously indicated by the parent network node or other network device) for selection by the network node, and/or explicit configuration information for the network node to use to configure the network node, among other examples.

In some aspects, the configuration information may indicate that the network node is to transmit information associated with a multiplexing capability of the network node for communications with a first mobile station and a second mobile station.

The network node may configure itself based at least in part on the configuration information. In some aspects, the network node may be configured to perform one or more operations described herein based at least in part on the configuration information.

As shown by reference number 610, the network node and the mobile stations may perform beam management procedures. For example, the network node may perform a beam management procedure during an initial connection procedure with a mobile station, and/or the network node may perform beam management procedures during an ongoing connection with the mobile stations to update beam selections for the mobile stations within coverage of the network node. For example, the network node may perform a beam management procedure with the first mobile station and the second mobile station.

As shown by reference number 615, the network node may identify support by a beam for communications with multiple mobile stations. For example, the network node may identify a beam (e.g., a network node beam for transmission and/or reception) that is selected for multiple mobile stations. Additionally, or alternatively, the network node may identify a beam that is not selected for each mobile station that is reachable via the beam. For example, the beam may not be a strongest beam (e.g., may not have a highest signal strength among all of the network node beams) for communication with at least one of the mobile stations that is reachable via the beam.

As shown by reference number 620, the network node may receive, and the parent network node may transmit, a request for the information associated with a multiplexing capability of the network node. For example, the request may indicate information elements to include in information to be transmitted to the parent network node. In some aspects, the request may indicate to include a list of mobile stations for which communications may be multiplexed using FDM multiplexing (e.g., using simultaneous transmission and/or reception, or using overlapping resources for transmission and/or reception). In some aspects, the request may indicate to include a list of serving beams and mobile stations that are served by each serving beam of the network node. In some aspects, the request may indicate to include a list of serving beams and mobile stations that are reachable by each serving beam. In some aspects, the request may indicate to include a list of serving beams and an indication of a signal strength for communications with connected mobile stations via respective serving beams.

As shown by reference number 625, the network node may receive, and the mobile station may transmit, a request for a SIB. For example, the mobile station may request the SIB as an extended SIB and/or a supplemental SIB for the mobile station to, for example, synchronize with the parent network node and/or to acquire a connection with the parent network node.

As shown by reference number 630, the network node may forward the request for the SIB to the parent network node.

As shown by reference number 635, the network node may transmit, and the parent network node may receive, the information associated with a multiplexing capability of the network node for communications with a first mobile station and a second mobile station of the mobile stations connected to the parent network node via the network node.

In some aspects, the information may include a report of beam assignments of connected mobile stations, indications of signal strengths of signals communicated between the network node and the connected mobile stations per beam of the network node, or an indication of one or more mobile stations in sets for which the network node support TDM.

In some aspects, the network node may transmit the information based at least in part on identification of a beam that supports communication with the first mobile station and the second mobile station, identification that the beam no longer supports communication with the first mobile station and the second mobile station, receiving a request for the information (e.g., as described in connection with reference number 620), or a configuration of a periodicity for transmitting the information (e.g., as indicated in the configuration information described in connection with reference number 605), and/or forwarding the request for the SIB, among other examples.

As shown by reference number 640, the network node may receive, and the parent network node may transmit, communications for the mobile stations with multiplexing that is based at least in part on the information transmitted by the network node. In some aspects, the communications may include a first communication for the first mobile station and a second communication for the second mobile station. The communications may be FDM-based multiplexed for mobile stations that are reachable via a same beam of the network node and/or for mobile stations that are associated with a same beam of the network node (e.g., having a same serving beam).

The communications may be time division multiplexing (TDM)-based multiplexed for mobile stations that are not reachable via a same beam of the network node. For example, the communications may be multiplexed with TDM based at least in part on the first mobile station and the second mobile station being associated with different beams of the network node, and/or based at least in part on the first mobile station and the second mobile station having signal strengths, associated with the same beam of the network node, that fail to satisfy a threshold.

In some aspects, the first communication may include a data or a control communication and the second communication includes a SIB. In some aspects, the SIB and the first communication may use different channels of the network, on different frequency resources.

As shown by reference number 645, the network node may forward the communications to the first mobile station and the second mobile station. For example, the network node may transmit the first communication for the first mobile station and a second communication for the second mobile station. The network node may forward the first communication and the second communication based at least in part on multiplexing that was applied by the parent network node to transmit the communications for the mobile stations as described in connection with reference number 640.

The communications may be FDM-based multiplexed for mobile stations that are reachable via a same beam of the network node. The communications may be TDM-based multiplexed (e.g., using resources that at least partially overlap in time) for mobile stations that are not reachable via a same beam of the network node. In this way, the network node may transmit the first communication to the first mobile station during a first set of time resources and may transmit the second communication to the second mobile station during a second set of time resources that do not overlap with the first set of time resources.

In some aspects, the TDM-based multiplexed communications are for mobile stations that are not reachable via a same beam of the network node and/or that are not associated with a same beam (e.g., having different serving beams). For example, the communications may be multiplexed with TDM based at least in part on the first mobile station and the second mobile station being associated with different beams of the network node, and/or based at least in part on the first mobile station and the second mobile station having signal strengths, associated with the same beam of the network node, that fail to satisfy a threshold.

This may avoid failure of the network node to forward one of the first communication or the second communication.

As shown by reference number 650, the network node may detect a change in multiplexing capability for multiplexing communications to the mobile stations. For example, the network node may detect that serving beams associated with the mobile stations have changed and/or that reachability via beams has changed, among other examples. In some aspects, the network node may detect a change that satisfies a change threshold.

As shown by reference number 655, the network node may transmit an update to the information. For example, the network node may transmit new information associated with the multiplexing capability of the network node. Alternatively, the network node may transmit a reduced amount of information to update one or more information elements of the information. For example, the network node may indicate to add a mobile station to a list of mobile stations reachable by a beam and/or may remove a mobile station from a list of mobile stations reachable by a beam. Additionally, or alternatively, the network node may indicate an update to the signal strengths of mobile stations when communicating via one or more beams of the network node.

Based at least in part on the network node providing the information associated with a multiplexing compatibility of the network node for communications with mobile stations connected to the parent network node via the network node, the parent network node may avoid multiplexing communications for incompatible mobile stations and/or conserve power, computing, network, and/or communication resources that may have otherwise been used to detect a failure of a communication that was not forwarded and/or to retransmit the communication.

As indicated above, FIG. 6 is provided as an example. Other examples may differ from what is described with regard to FIG. 6.

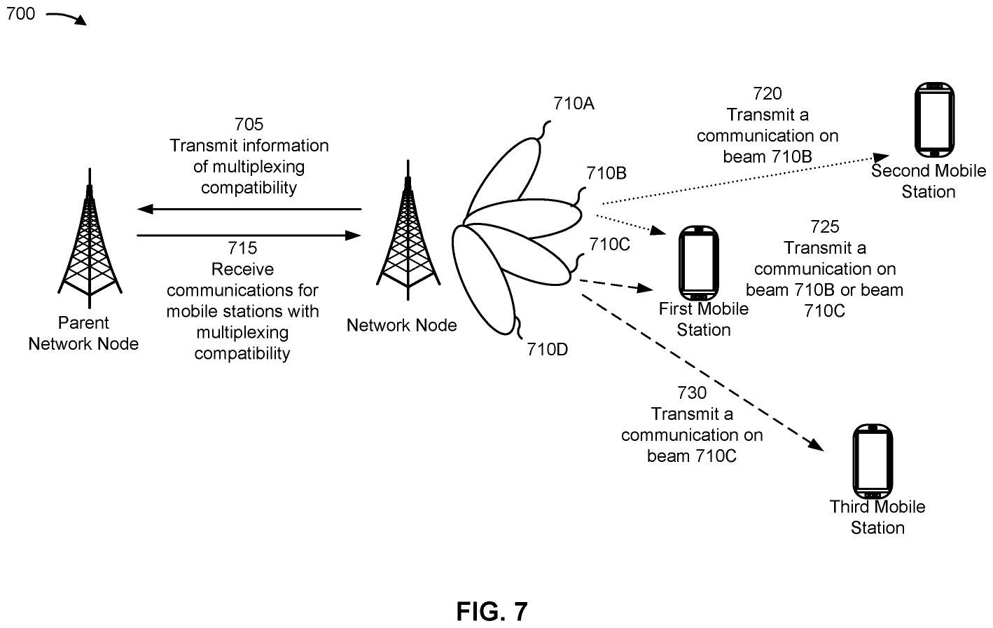

FIG. 7 is a diagram of an example 700 associated with multiplexing at a forwarding node, in accordance with the present disclosure. As shown in FIG. 7, a network node (e.g., network node 110, an IAB node, a repeater, a forwarding node, a relay, a DU, and/or an RU) may communicate with a parent network node (e.g., network node 110, an IAB node, a repeater, a forwarding node, a relay, a CU, a DU, and/or an RU) and mobile stations (e.g., UEs 120). In some aspects, the network node, the parent network node, and/or the mobile stations may be part of a wireless network (e.g., wireless network 100). The network node, the parent network node, and/or the mobile stations may have established a wireless connection prior to operations shown in FIG. 7.

As shown in FIG. 7, a parent network node may attempt to transmit communications, using FDM multiplexing, to a first mobile station (e.g., UE 120), a second mobile station, and a third mobile station via a network node (e.g., a relay, a repeater, and/or a forwarding node, among other examples). The parent network node may support transmission of the communications with FDM-based multiplexing and/or TDM-based multiplexing.

As shown by reference number 705, the network node may transmit information of a multiplexing capability of the network node for communicating with mobile stations connected to the parent network node via the network node. For example, the network node may indicate sets of one or more of the mobile stations that may use time resources that at least partially overlap (e.g., using FDM).

The network node may support, operate, and/or communicate with mobile stations via a set of beams 710A, 710B, 710C, and 710D. However, the network node may not support FDM-based multiplexing (e.g., using simultaneous and/or overlapping communications) of communications on different beams. As shown in example 700, the first mobile station may have communications multiplexed with communications for either the second mobile station or for the third mobile station. This is because the first mobile station may be reachable via the beam 710B along with the second mobile station or reachable via the beam 710C along with the third mobile station.

As shown by reference number 715, the network node may receive communications for mobile stations with a multiplexing capability. For example, the communications may include FDM-based communications for the first mobile station and the second mobile station, FDM-based communications for the first mobile station and the third mobile station, and/or TDM-based communications for the second mobile station and the third mobile station (e.g., on non-overlapping time resources)

As shown by reference number 720, the network node may transmit a communication to the second mobile station and, as shown by reference number 725, the network node may transmit a communication to the first mobile station using the beam 710B. For example, the network node may multiplex, using FDM (with time resources that at least partially overlap), the communication to the second mobile station and the communication to the first mobile station.

As shown by reference number 730, the network node may transmit a communication to the third mobile station and, as shown by reference number 725, the network node may transmit a communication to the first mobile station using the beam 710C. For example, the network node may multiplex, using FDM (with time resources that at least partially overlap), the communication to the third mobile station and the communication to the first mobile station.

As indicated above, FIG. 7 is provided as an example. Other examples may differ from what is described with regard to FIG. 7.

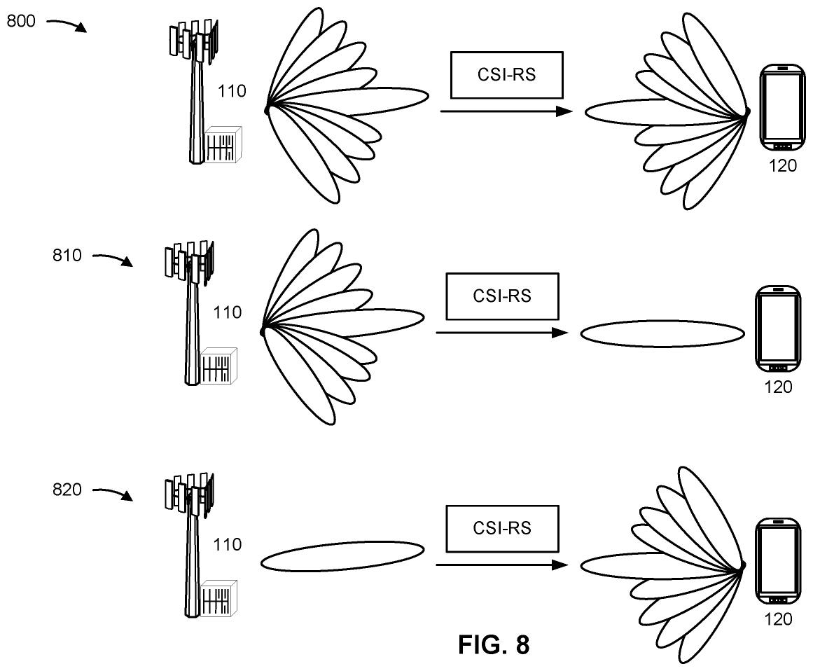

FIG. 8 is a diagram illustrating examples 800, 810, and 820 of beam management procedures, in accordance with the present disclosure. As shown in FIG. 8, examples 800, 810, and 820 include a UE 120 in communication with a network node 110 in a wireless network (e.g., wireless network 100). However, the devices shown in FIG. 8 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (e.g., an RRC connected state).

As shown in FIG. 8, example 800 may include a network node 110 (e.g., one or more network node devices such as an RU, a DU, and/or a CU, among other examples) and a UE 120 communicating to perform beam management (e.g., using channel state information reference signals (CSI-RSs) and/or or synchronization signal blocks (SSBs)). Example 800 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 8 and example 800, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 800 has been described in connection with CSI-RSs, the first beam management process may also use SSBs for beam management in a similar manner as described above.

As shown in FIG. 8, example 810 may include a network node 110 and a UE 120 communicating to perform beam management using CSI-RSs. Example 810 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 8 and example 810, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 8, example 820 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 8 and example 820, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

In some aspects, the network node and the mobile stations of FIG. 7 may perform beam management procedures similar to those described in connection with FIG. 8.

As indicated above, FIG. 8 is provided as an example of beam management procedures. Other examples of beam management procedures may differ from what is described with respect to FIG. 8. For example, the UE 120 and the network node 110 may perform the third beam management procedure before performing the second beam management procedure, and/or the UE 120 and the network node 110 may perform a similar beam management procedure to select a UE transmit beam.

FIG. 9 is a diagram illustrating an example process 900 performed, for example, by a network node, in accordance with the present disclosure. Example process 900 is an example where the network node (e.g., network node 110) performs operations associated with multiplexing at a forwarding node.

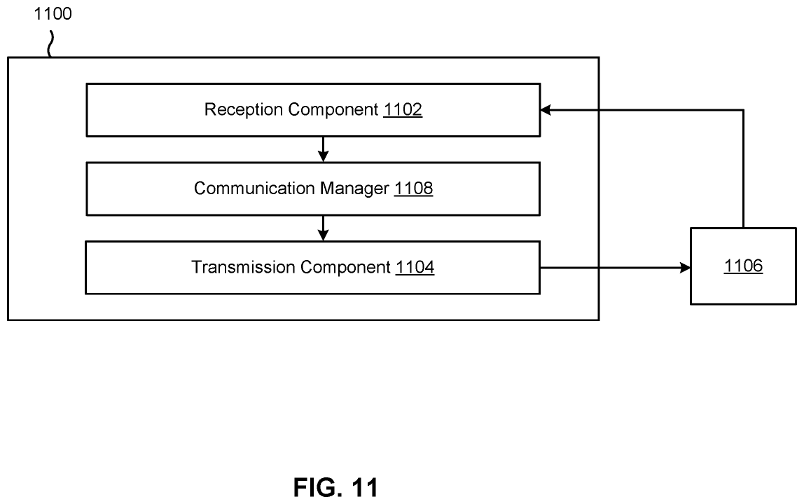

As shown in FIG. 9, in some aspects, process 900 may include transmitting, to a parent network node, information associated with a multiplexing compatibility of the network node for communications with a first mobile station and a second mobile station, the first mobile station and the second mobile station connected to the parent network node via the network node (block 910). For example, the network node (e.g., using communication manager 150 and/or transmission component 1104, depicted in FIG. 11) may transmit, to a parent network node, information associated with a multiplexing compatibility of the network node for communications with a first mobile station and a second mobile station, the first mobile station and the second mobile station connected to the parent network node via the network node, as described above.

As further shown in FIG. 9, in some aspects, process 900 may include receiving, from the parent network node, a first communication for the first mobile station and a second communication for the second mobile station, the first communication and the second communication multiplexed based at least in part on the information associated with the multiplexing compatibility of the network node for communications with the first mobile station and the second mobile station (block 920). For example, the network node (e.g., using communication manager 150 and/or reception component 1102, depicted in FIG. 11) may receive, from the parent network node, a first communication for the first mobile station and a second communication for the second mobile station, the first communication and the second communication multiplexed based at least in part on the information associated with the multiplexing compatibility of the network node for communications with the first mobile station and the second mobile station, as described above.

Process 900 may include additional aspects, such as any single aspect or any combination of aspects described below and/or in connection with one or more other processes described elsewhere herein.

In a first aspect, the first communication and the second communication are multiplexed with FDM based at least in part on one or more of the first mobile station and the second mobile station being associated with a same beam of the network node, or the first mobile station and the second mobile station having signal strengths, associated with the same beam of the network node, that satisfy a threshold.

In a second aspect, alone or in combination with the first aspect, process 900 includes transmitting the first communication and the second communication using resources that at least partially overlap in time.

In a third aspect, alone or in combination with one or more of the first and second aspects, the first communication and the second communication are multiplexed with TDM based at least in part on one or more of the first mobile station and the second mobile station being associated with different beams of the network node, or the first mobile station and the second mobile station having signal strengths, associated with the same beam of the network node, that fail to satisfy a threshold.

In a fourth aspect, alone or in combination with one or more of the first through third aspects, the information associated with the multiplexing compatibility of the network node comprises a report of beam assignments of connected mobile stations, indications of signal strengths of signals communicated between the network node and the connected mobile stations per beam of the network node, or an indication of one or more mobile stations in sets that support FDM.

In a fifth aspect, alone or in combination with one or more of the first through fourth aspects, process 900 includes performing, before transmitting the information associated with the multiplexing capability of the network node, a beam management procedure with the first mobile station and the second mobile station.

In a sixth aspect, alone or in combination with one or more of the first through fifth aspects, process 900 includes transmitting an update to the information based at least in part on detection of a change in the multiplexing compatibility of the network node associated with communications with the first mobile station and the second mobile station.

In a seventh aspect, alone or in combination with one or more of the first through sixth aspects, transmitting the information associated with the multiplexing capability of the network node is based at least in part on one or more of identification of a beam that supports communication with the first mobile station and the second mobile station, identification that the beam no longer supports communication with the first mobile station and the second mobile station, receiving a request for the information, or a configuration of a periodicity for transmitting the information.

In an eighth aspect, alone or in combination with one or more of the first through seventh aspects, the first communication comprises a data communication, and the second communication comprises a mobile station requested SIB.

In a ninth aspect, alone or in combination with one or more of the first through eighth aspects, process 900 includes forwarding a request, from the second mobile station and to the parent network node, for the mobile station-requested SIB.

In a tenth aspect, alone or in combination with one or more of the first through ninth aspects, transmitting of the information associated with the multiplexing capability of the network node is based at least in part on forwarding the request for the mobile station-requested SIB.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a parent network node, in accordance with the present disclosure. Example process 1000 is an example where the parent network node (e.g., parent network node 110) performs operations associated with multiplexing at a forwarding node.

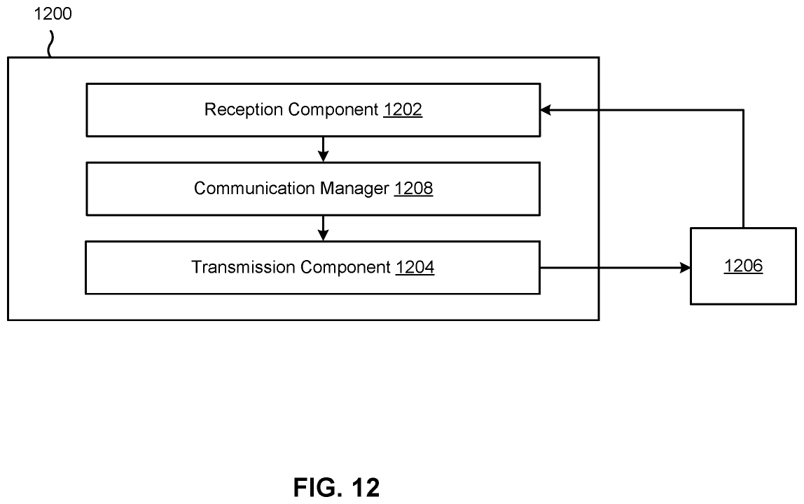

As shown in FIG. 10, in some aspects, process 1000 may include receiving, from a network node, information associated with a multiplexing compatibility of the network node for communications with a first mobile station and a second mobile station, the first mobile station and the second mobile station connected to the parent network node via the network node (block 1010). For example, the parent network node (e.g., using communication manager 150 and/or reception component 1202, depicted in FIG. 12) may receive, from a network node, information associated with a multiplexing compatibility of the network node for communications with a first mobile station and a second mobile station, the first mobile station and the second mobile station connected to the parent network node via the network node, as described above.

As further shown in FIG. 10, in some aspects, process 1000 may include transmitting, to the network node, a first communication for the first mobile station and a second communication for the second mobile station, the first communication and the second communication multiplexed based at least in part on the information associated with the multiplexing compatibility of the network node for communications with the first mobile station and the second mobile station (block 1020). For example, the parent network node (e.g., using communication manager 150 and/or transmission component 1204, depicted in FIG. 12) may transmit, to the network node, a first communication for the first mobile station and a second communication for the second mobile station, the first communication and the second communication multiplexed based at least in part on the information associated with the multiplexing compatibility of the network node for communications with the first mobile station and the second mobile station, as described above.

Process 1000 may include additional aspects, such as any single aspect or any combination of aspects described below and/or in connection with one or more other processes described elsewhere herein.

In a first aspect, the first communication and the second communication are multiplexed with FDM based at least in part on one or more of the first mobile station and the second mobile station being associated with a same beam of the network node, or the first mobile station and the second mobile station having signal strengths, associated with the same beam of the network node, that satisfy a threshold.

In a second aspect, alone or in combination with the first aspect, transmitting the first communication and the second communication comprises transmitting the first communication and the second communication using resources that at least partially overlap in time.

In a third aspect, alone or in combination with one or more of the first and second aspects, the first communication and the second communication are multiplexed with TDM based at least in part on one or more of the first mobile station and the second mobile station being associated with different beams of the network node, or the first mobile station and the second mobile station having signal strengths, associated with the same beam of the network node, that fail to satisfy a threshold.

In a fourth aspect, alone or in combination with one or more of the first through third aspects, the information associated with the multiplexing compatibility of the network node comprises a report of beam assignments of connected mobile stations, indications of signal strengths of signals communicated between the network node and the connected mobile stations per beam of the network node, or an indication of one or more mobile stations in sets that support FDM.

In a fifth aspect, alone or in combination with one or more of the first through fourth aspects, process 1000 includes receiving an update to the information based at least in part on detection of a change in the multiplexing compatibility of the network node associated with communications with the first mobile station and the second mobile station.

In a sixth aspect, alone or in combination with one or more of the first through fifth aspects, receiving the information associated with the multiplexing capability of the network node is based at least in part on one or more of identification, by the network node, of a beam that supports communication with the first mobile station and the second mobile station, identification, by the network node, that the beam no longer supports communication with the first mobile station and the second mobile station, transmitting a request for the information, or a configuration of a periodicity for transmitting the information.

In a seventh aspect, alone or in combination with one or more of the first through sixth aspects, the first communication comprises a data communication, and the second communication comprises a mobile station-requested SIB.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108 (e.g., the communication manager 150).

In some aspects, the apparatus 1100 may be configured to perform one or more operations described herein in connection with FIGS. 6-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The transmission component 1104 may transmit, to a parent network node, information associated with a multiplexing compatibility of the network node for communications with a first mobile station and a second mobile station, the first mobile station and the second mobile station connected to the parent network node via the network node. The reception component 1102 may receive, from the parent network node, a first communication for the first mobile station and a second communication for the second mobile station, the first communication and the second communication multiplexed based at least in part on the information associated with the multiplexing compatibility of the network node for communications with the first mobile station and the second mobile station.

The transmission component 1104 may transmit the first communication and the second communication using resources that at least partially overlap in time.

The communication manager 1108 may perform, before transmitting the information associated with the multiplexing capability of the network node, a beam management procedure with the first mobile station and the second mobile station.

The transmission component 1104 may transmit an update to the information based at least in part on detection of a change in the multiplexing compatibility of the network node associated with communications with the first mobile station and the second mobile station.

The transmission component 1104 may forward a request, from the second mobile station and to the parent network node, for the mobile station-requested SIB.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a parent network node, or a parent network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a communication manager 1208 (e.g., the communication manager 150).

In some aspects, the apparatus 1200 may be configured to perform one or more operations described herein in connection with FIGS. 6-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the parent network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the parent network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the parent network node described in connection with FIG. 2. In some aspects, the transmission component 1204 may be co-located with the reception component 1202 in a transceiver.

The reception component 1202 may receive, from a network node, information associated with a multiplexing compatibility of the network node for communications with a first mobile station and a second mobile station, the first mobile station and the second mobile station connected to the parent network node via the network node. The transmission component 1204 may transmit, to the network node, a first communication for the first mobile station and a second communication for the second mobile station, the first communication and the second communication multiplexed based at least in part on the information associated with the multiplexing compatibility of the network node for communications with the first mobile station and the second mobile station.

The reception component 1202 may receive an update to the information based at least in part on detection of a change in the multiplexing compatibility of the network node associated with communications with the first mobile station and the second mobile station.

The reception component 1202 may receive a request, forwarded from the second mobile station and to the parent network node, for the mobile station-requested SIB.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a network node, comprising: transmitting, to a parent network node, information associated with a multiplexing compatibility of the network node for communications with a first mobile station and a second mobile station, the first mobile station and the second mobile station connected to the parent network node via the network node; and receiving, from the parent network node, a first communication for the first mobile station and a second communication for the second mobile station, the first communication and the second communication multiplexed based at least in part on the information associated with the multiplexing compatibility of the network node for communications with the first mobile station and the second mobile station.

Aspect 2: The method of Aspect 1, wherein the first communication and the second communication are multiplexed with frequency division multiplexing (FDM) based at least in part on one or more of: the first mobile station and the second mobile station being associated with a same beam of the network node, or the first mobile station and the second mobile station having signal strengths, associated with the same beam of the network node, that satisfy a threshold.

Aspect 3: The method of Aspect 2, further comprising: transmitting the first communication and the second communication using resources that at least partially overlap in time.

Aspect 4: The method of any of Aspects 1-3, wherein the first communication and the second communication are multiplexed with time division multiplexing (TDM) based at least in part on one or more of: the first mobile station and the second mobile station being associated with different beams of the network node, or the first mobile station and the second mobile station having signal strengths, associated with the same beam of the network node, that fail to satisfy a threshold.

Aspect 5: The method of any of Aspects 1-4, wherein the information associated with the multiplexing compatibility of the network node comprises: a report of beam assignments of connected mobile stations, indications of signal strengths of signals communicated between the network node and the connected mobile stations per beam of the network node, or an indication of one or more mobile stations in sets that support frequency division multiplexing (FDM).

Aspect 6: The method of any of Aspects 1-5, further comprising: performing, before transmitting the information associated with the multiplexing capability of the network node, a beam management procedure with the first mobile station and the second mobile station.

Aspect 7: The method of any of Aspects 1-6, further comprising: transmitting an update to the information based at least in part on detection of a change in the multiplexing compatibility of the network node associated with communications with the first mobile station and the second mobile station.

Aspect 8: The method of any of Aspects 1-7, wherein transmitting the information associated with the multiplexing capability of the network node is based at least in part on one or more of: identification of a beam that supports communication with the first mobile station and the second mobile station, identification that the beam no longer supports communication with the first mobile station and the second mobile station, receiving a request for the information, or a configuration of a periodicity for transmitting the information.

Aspect 9: The method of any of Aspects 1-8, wherein the first communication comprises a data communication, and wherein the second communication comprises a mobile station-requested system information block (SIB).

Aspect 10: The method of Aspect 9, further comprising: forwarding a request, from the second mobile station and to the parent network node, for the mobile station-requested SIB.

Aspect 11: The method of Aspect 10, wherein transmitting of the information associated with the multiplexing capability of the network node is based at least in part on forwarding the request for the mobile station-requested SIB.

Aspect 12: A method of wireless communication performed by a parent network node, comprising: receiving, from a network node, information associated with a multiplexing compatibility of the network node for communications with a first mobile station and a second mobile station, the first mobile station and the second mobile station connected to the parent network node via the network node; and transmitting, to the network node, a first communication for the first mobile station and a second communication for the second mobile station, the first communication and the second communication multiplexed based at least in part on the information associated with the multiplexing compatibility of the network node for communications with the first mobile station and the second mobile station.

Aspect 13: The method of Aspect 12, wherein the first communication and the second communication are multiplexed with frequency division multiplexing (FDM) based at least in part on one or more of: the first mobile station and the second mobile station being associated with a same beam of the network node, or the first mobile station and the second mobile station having signal strengths, associated with the same beam of the network node, that satisfy a threshold.

Aspect 14: The method of Aspect 13, wherein transmitting the first communication and the second communication comprises: transmitting the first communication and the second communication using resources that at least partially overlap in time.

Aspect 15: The method of any of Aspects 12-14, wherein the first communication and the second communication are multiplexed with time division multiplexing (TDM) based at least in part on one or more of: the first mobile station and the second mobile station being associated with different beams of the network node, or the first mobile station and the second mobile station having signal strengths, associated with the same beam of the network node, that fail to satisfy a threshold.

Aspect 16: The method of any of Aspects 12-15, wherein the information associated with the multiplexing compatibility of the network node comprises: a report of beam assignments of connected mobile stations, indications of signal strengths of signals communicated between the network node and the connected mobile stations per beam of the network node, or an indication of one or more mobile stations in sets that support frequency division multiplexing (FDM).

Aspect 17: The method of any of Aspects 12-16, further comprising: receiving an update to the information based at least in part on detection of a change in the multiplexing compatibility of the network node associated with communications with the first mobile station and the second mobile station.

Aspect 18: The method of any of Aspects 12-17, wherein receiving the information associated with the multiplexing capability of the network node is based at least in part on one or more of: identification, by the network node, of a beam that supports communication with the first mobile station and the second mobile station, identification, by the network node, that the beam no longer supports communication with the first mobile station and the second mobile station, transmitting a request for the information, or a configuration of a periodicity for transmitting the information.

Aspect 19: The method of any of Aspects 12-18, wherein the first communication comprises a data communication, and wherein the second communication comprises a mobile station-requested system information block (SIB).

Aspect 20: The method of Aspect 19, further comprising: receiving a request, forwarded from the second mobile station and to the parent network node, for the mobile station-requested SIB.

Aspect 21: The method of Aspect 20, wherein reception of the information associated with the multiplexing capability of the network node is based at least in part on receiving the request for the mobile station-requested SIB.

Aspect 22: An apparatus for wireless communication at a device, comprising a processor; memory coupled with the processor; and instructions stored in the memory and executable by the processor to cause the apparatus to perform the method of one or more of Aspects 1-21.

Aspect 23: A device for wireless communication, comprising a memory and one or more processors coupled to the memory, the one or more processors configured to perform the method of one or more of Aspects 1-21.

Aspect 24: An apparatus for wireless communication, comprising at least one means for performing the method of one or more of Aspects 1-21.

Aspect 25: A non-transitory computer-readable medium storing code for wireless communication, the code comprising instructions executable by a processor to perform the method of one or more of Aspects 1-21.

Aspect 26: A non-transitory computer-readable medium storing a set of instructions for wireless communication, the set of instructions comprising one or more instructions that, when executed by one or more processors of a device, cause the device to perform the method of one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network node for wireless communication, comprising:
a memory; and
one or more processors that, based at least in part on information stored in the memory, are configured to:
transmit, to a parent network node, information associated with a multiplexing compatibility of the network node for communications with a first mobile station and a second mobile station, the first mobile station and the second mobile station connected to the parent network node via the network node; and
receive, from the parent network node, a first communication for the first mobile station and a second communication for the second mobile station, the first communication and the second communication multiplexed based at least in part on the information associated with the multiplexing compatibility of the network node for communications with the first mobile station and the second mobile station.

2. The network node of claim 1, wherein the first communication and the second communication are multiplexed with frequency division multiplexing (FDM) based at least in part on one or more of:
the first mobile station and the second mobile station being associated with a same beam of the network node, or
the first mobile station and the second mobile station having signal strengths, associated with the same beam of the network node, that satisfy a threshold.

3. The network node of claim 2, wherein the one or more processors are further configured to:
transmit the first communication and the second communication using resources that at least partially overlap in time.

4. The network node of claim 1, wherein the first communication and the second communication are multiplexed with time division multiplexing (TDM) based at least in part on one or more of:
the first mobile station and the second mobile station being associated with different beams of the network node, or
the first mobile station and the second mobile station having signal strengths, associated with the same beam of the network node, that fail to satisfy a threshold.

5. The network node of claim 1, wherein the information associated with the multiplexing compatibility of the network node comprises:
a report of beam assignments of connected mobile stations,
indications of signal strengths of signals communicated between the network node and the connected mobile stations per beam of the network node, or
an indication of one or more mobile stations in sets that support frequency division multiplexing (FDM).

6. The network node of claim 1, wherein the one or more processors are further configured to:
perform, before transmitting the information associated with the multiplexing capability of the network node, a beam management procedure with the first mobile station and the second mobile station.

7. The network node of claim 1, wherein the one or more processors are further configured to:
transmit an update to the information based at least in part on detection of a change in the multiplexing compatibility of the network node associated with communications with the first mobile station and the second mobile station.

8. The network node of claim 1, wherein transmitting the information associated with the multiplexing capability of the network node is based at least in part on one or more of:
identification of a beam that supports communication with the first mobile station and the second mobile station,
identification that the beam no longer supports communication with the first mobile station and the second mobile station,
receiving a request for the information, or
a configuration of a periodicity for transmitting the information.

9. The network node of claim 1, wherein the first communication comprises a data communication, and
wherein the second communication comprises a mobile station-requested system information block (SIB).

10. The network node of claim 9, wherein the one or more processors are further configured to:
forward a request, from the second mobile station and to the parent network node, for the mobile station-requested SIB.

11. The network node of claim 10, wherein transmitting of the information associated with the multiplexing capability of the network node is based at least in part on forwarding the request for the mobile station-requested SIB.

12. A parent network node for wireless communication, comprising:
a memory; and
one or more processors that, based at least in part on information stored in the memory, are configured to:
receive, from a network node, information associated with a multiplexing compatibility of the network node for communications with a first mobile station and a second mobile station, the first mobile station and the second mobile station connected to the parent network node via the network node; and
transmit, to the network node, a first communication for the first mobile station and a second communication for the second mobile station, the first communication and the second communication multiplexed based at least in part on the information associated with the multiplexing compatibility of the network node for communications with the first mobile station and the second mobile station.

13. The parent network node of claim 12, wherein the first communication and the second communication are multiplexed with frequency division multiplexing (FDM) based at least in part on one or more of:
the first mobile station and the second mobile station being associated with a same beam of the network node, or
the first mobile station and the second mobile station having signal strengths, associated with the same beam of the network node, that satisfy a threshold.

14. The parent network node of claim 13, wherein the one or more processors, to transmit the first communication and the second communication, are configured to:
transmit the first communication and the second communication using resources that at least partially overlap in time.

15. The parent network node of claim 12, wherein the first communication and the second communication are multiplexed with time division multiplexing (TDM) based at least in part on one or more of:
the first mobile station and the second mobile station being associated with different beams of the network node, or
the first mobile station and the second mobile station having signal strengths, associated with the same beam of the network node, that fail to satisfy a threshold.

16. The parent network node of claim 12, wherein the information associated with the multiplexing compatibility of the network node comprises:
a report of beam assignments of connected mobile stations,
indications of signal strengths of signals communicated between the network node and the connected mobile stations per beam of the network node, or
an indication of one or more mobile stations in sets that support time division multiplexing (TDM).

17. The parent network node of claim 12, wherein the one or more processors are further configured to:
receive an update to the information based at least in part on detection of a change in the multiplexing compatibility of the network node associated with communications with the first mobile station and the second mobile station.

18. The parent network node of claim 12, wherein receiving the information associated with the multiplexing capability of the network node is based at least in part on one or more of:
identification, by the network node, of a beam that supports communication with the first mobile station and the second mobile station,
identification, by the network node, that the beam no longer supports communication with the first mobile station and the second mobile station,
transmitting a request for the information, or
a configuration of a periodicity for transmitting the information.

19. The parent network node of claim 12, wherein the first communication comprises a data communication, and
wherein the second communication comprises a mobile station-requested system information block (SIB).

20. The parent network node of claim 19, wherein the one or more processors are further configured to:
receive a request, forwarded from the second mobile station and to the parent network node, for the mobile station-requested SIB.

21. The parent network node of claim 20, wherein reception of the information associated with the multiplexing capability of the network node is based at least in part on receiving the request for the mobile station-requested SIB.

22. A method of wireless communication performed by a network node, comprising:
transmitting, to a parent network node, information associated with a multiplexing compatibility of the network node for communications with a first mobile station and a second mobile station, the first mobile station and the second mobile station connected to the parent network node via the network node; and
receiving, from the parent network node, a first communication for the first mobile station and a second communication for the second mobile station, the first communication and the second communication multiplexed based at least in part on the information associated with the multiplexing compatibility of the network node for communications with the first mobile station and the second mobile station.

23. The method of claim 22, wherein the first communication and the second communication are multiplexed with frequency division multiplexing (FDM) based at least in part on one or more of:
the first mobile station and the second mobile station being associated with a same beam of the network node, or
the first mobile station and the second mobile station having signal strengths, associated with the same beam of the network node, that satisfy a threshold.

24. The method of claim 23, further comprising:
transmitting the first communication and the second communication using resources that at least partially overlap in time.

25. The method of claim 22, wherein the first communication and the second communication are multiplexed with time division multiplexing (TDM) based at least in part on one or more of:
the first mobile station and the second mobile station being associated with different beams of the network node, or
the first mobile station and the second mobile station having signal strengths, associated with the same beam of the network node, that fail to satisfy a threshold.

26. The method of claim 22, wherein the information associated with the multiplexing compatibility of the network node comprises:
a report of beam assignments of connected mobile stations,
indications of signal strengths of signals communicated between the network node and the connected mobile stations per beam of the network node, or
an indication of one or more mobile stations in sets that support frequency division multiplexing (FDM).

27. A method of wireless communication performed by a parent network node, comprising:
receiving, from a network node, information associated with a multiplexing compatibility of the network node for communications with a first mobile station and a second mobile station, the first mobile station and the second mobile station connected to the parent network node via the network node; and
transmitting, to the network node, a first communication for the first mobile station and a second communication for the second mobile station, the first communication and the second communication multiplexed based at least in part on the information associated with the multiplexing compatibility of the network node for communications with the first mobile station and the second mobile station.

28. The method of claim 27, wherein the first communication and the second communication are multiplexed with frequency division multiplexing (FDM) based at least in part on one or more of:
the first mobile station and the second mobile station being associated with a same beam of the network node, or
the first mobile station and the second mobile station having signal strengths, associated with the same beam of the network node, that satisfy a threshold.

29. The method of claim 28, wherein transmitting the first communication and the second communication comprises:
transmitting the first communication and the second communication using resources that at least partially overlap in time.

30. The method of claim 27, wherein the first communication and the second communication are multiplexed with time division multiplexing (TDM) based at least in part on one or more of:
the first mobile station and the second mobile station being associated with different beams of the network node, or
the first mobile station and the second mobile station having signal strengths, associated with the same beam of the network node, that fail to satisfy a threshold.
